(19) United States
(12) Patent Application Publication
(10) Pub. No.: US 2026/0091446 A1
(43) Pub. Date: Apr. 2, 2026

(54) METHOD FOR PREPARING ALLOY FOR DIFFUSION BONDING, AND DIFFUSION BONDING MATERIAL PRODUCED USING METHOD FOR PREPARING ALLOY FOR DIFFUSION BONDING

(71) Applicant: KOREA ATOMIC ENERGY RESEARCH INSTITUTE, Daejeon (KR)

(72) Inventors: Jong Bae HWANG, Chungju-si (KR); Injin SAH, Sejong (KR); Eung Seon KIM, Seoul (KR)

(73) Assignee: KOREA ATOMIC ENERGY RESEARCH INSTITUTE, Daejeon (KR)

(21) Appl. No.: 19/108,964

(22) PCT Filed: Sep. 5, 2023
(86) PCT No.: PCT/KR2023/013216

§ 371 Date: Mar. 5, 2025

(30) Foreign Application Priority Data
Sep. 5, 2022 (KR) 10-2022-0112283

(51) Int. Cl. B23K 20/02; B23K 20/227; B23K 20/24

(52) U.S. Cl. CPC B23K 20/02; B23K 20/227; B23K 20/24

(57) ABSTRACT

The present invention relates to a method for preparing an alloy for diffusion bonding, comprising a matrix and an alloyed region having a different chemical composition from the matrix, and the method may comprise: (a) a coating step of forming an alloy precursor layer containing nickel (Ni) on the surface of a base material; (b) a surface alloying step of forming an alloyed region by mixing the base material and constituent elements of the alloy precursor layer, and (c) a polishing step of preparing an alloy surface for diffusion bonding by removing at least a portion of the alloyed region.

### TECHNICAL FIELD

The present invention relates to a preparation method for diffusion bonding of an alloy and a diffusion bonding member produced by using the preparing method for diffusion bonding of an alloy.

### BACKGROUND ART

Bonding is classified into liquid bonding and solid bonding depending on whether the material is melted in the process of connecting materials. Diffusion bonding is one method of solid bonding, and it is a technique that connects materials by using the thermal diffusion of atoms at high temperatures.

In the related art, alloys were diffusion-bonded with temperature, pressure, environment, surface treatment, post-heat treatment, filler material and the like as process variables. In the case of diffusion bonding according to the related art, titanium (Ti) and carbon (C) included in the alloy react, or aluminum (Al) and oxygen (O) react to form a secondary precipitate such as Ti-rich carbide or Al-rich oxide. The secondary phase formed at the diffusion bonding member interface forms a planar grain boundary by limiting grain boundary migration across the diffusion bonding member interface. This planar grain boundary reduces the high-temperature mechanical properties of the diffusion bonding member.

Until the melting point of the alloy is reached, Ti-rich carbides or Al-rich oxides formed at the diffusion bonding member interface do not dissolve into the matrix. Therefore, when the secondary phase is formed at the diffusion bonding member interface, there is a limitation to promoting the grain boundary migration across the diffusion bonding member interface through post-heat treatment used in the related art. Meanwhile, when diffusion bonding is performed for an alloy by inserting a filler metal, diffusion-induced grain boundary migration may occur due to a chemical composition gradient between the filler metal and the alloy to be diffusion-bonded. Accordingly, the planar grain boundary observed at the diffusion bonding member interface can be changed into an equiaxed grain boundary. However, when a filler material is used, the secondary phase that causes brittle fracture may be formed at or near the diffusion bonding member interface.

### DISCLOSURE

### Technical Problem

One of the various objects of the present invention is to minimize the formation of a secondary phase (e.g., Ti-rich carbide, Al-rich oxide or Nis (Al, Ti) intermetallic compound) formed at or near the diffusion bonding member interface.

One of the various objects of the present invention is to promote grain boundary migration across the diffusion bonding member interface.

One of the various objects of the present invention is to secure the soundness of a diffusion bonding member at room temperature and high temperature.

One of the various objects of the present invention is to provide a diffusion bonding member and a diffusion bonding method of an alloy having mechanical properties comparable to those of a base material at room temperature and high temperature.

However, the technical problem to be achieved by the present invention is not limited to the above-mentioned problem, and other problems that are not mentioned will be clearly understood by those skilled in the art from the description below.

### Technical Solution

The present invention locally changes the chemical composition of the surface and near the surface of an alloy to solve the problem that the grain boundary migration across the diffusion bonding material interface is limited by the secondary phase formed at or near the diffusion bonding material interface.

### Advantageous Effects

One of the various effects of the present invention is to minimize the formation of a secondary phase at or near the diffusion bonding member interface.

One of the various effects of the present invention is that it is possible to form a grain boundary migration region across the diffusion bonding member interface.

One of the various effects of the present invention is to provide a diffusion bonding member and a diffusion bonding method of an alloy having mechanical properties comparable to those of a base material at room temperature and high temperature.

### DESCRIPTION OF DRAWINGS

FIG. 1 is a flow chart mimetically showing a preparation method for an alloy for diffusion bonding and a diffusion bonding method according to the present invention.

FIG. 2 is a cross-sectional diagram mimetically showing an alloy for diffusion bonding according to the present invention.

FIG. 3 is a cross-sectional diagram mimetically showing a diffusion bonding member according to the present invention.

FIG. 4 is an image of the cross section of an alloy for diffusion bonding according to the present invention taken with a scanning electron microscope (SEM).

FIGS. 5 to 8 show the analysis of the distribution of the constituent elements (Fe (FIG. 5), Ni (FIG. 6), Cr (FIG. 7) and Ti (FIG. 8)) by using the electron probe micro-analysis (EPMA) method for the cross section of FIG. 4.

FIG. 9 is an image of the cross section of a diffusion bonding member according to an exemplary embodiment of the present invention taken with an optical microscope (OM).

FIGS. 10 to 12 are stress-strain curves at room temperature (25° C.) of the base material, the example and comparative example, respectively.

FIGS. 13 to 15 are stress-strain curves at 600° C. of the base material, the example and comparative example, respectively.

### MODES OF THE INVENTION

Hereinafter, the exemplary embodiments of the present invention will be described with reference to specific exemplary embodiments and accompanying drawings. It is to be understood that the techniques described herein are not limited to the specific exemplary embodiments, and include various modifications, equivalents and/or alternatives of the exemplary embodiments of the present invention. In connection with the description of the drawings, like reference numerals may be used for like components.

Further, in order to clearly describe the present invention in the drawings, parts that are irrelevant to the description are omitted, and the thickness is enlarged in order to clearly express various layers and regions, and components having the same function within the scope of the same spirit may be explained by using the same reference numerals.

In the present specification, expressions such as “have”, “may have”, “include” or “may include” indicate the presence of a corresponding feature (e.g., numerical value, function, operation or component such as a part), and they do not preclude the existence of additional features.

In the present specification, expressions such as “A or B”, “at least one of A and/and B” or “one or more of A or/and B” may include all possible combinations of the items listed together. For example, “A or B”, “at least one of A and B” or “at least one of A or B” may refer to all cases including (1) at least one A, (2) at least one B or (3) at least one A and at least one B.

The present invention relates to a method for preparing an alloy for diffusion bonding. The method for preparing an alloy for diffusion bonding according to the present invention may include (a) a coating step of forming an alloy precursor layer including nickel (Ni) on the surface of a base material; (b) a surface alloying step of forming an alloying region by mixing the base material and constituent elements of the alloy precursor layer; and (c) a polishing step of preparing an alloy surface for diffusion bonding by removing at least a portion of the alloying region. The method for preparing an alloy for diffusion bonding may refer to a method of processing an alloy for diffusion bonding for manufacturing a diffusion bonding member to be described below. In the case of diffusion bonding using an alloy for diffusion bonding prepared by the method for preparing an alloy for diffusion bonding according to the present invention, since the formation of a secondary phase carbide or oxide series can be suppressed at the diffusion bonding member interface, it is possible to provide a diffusion bonding member having excellent mechanical properties and soundness.

In this case, at least a portion of the alloying region of the diffusion bonding alloy may be exposed to the surface of the alloy for diffusion bonding. The fact that at least a portion of the alloying region is exposed to the surface of the alloy for diffusion bonding may mean that the alloying region is formed on and near the surface of the alloy. The alloying region functions as an interface to be bonded to each other in the subsequent diffusion bonding process, and a grain boundary migration region may be formed through the presence of the alloying region exposed to the surface, and it is possible to manufacture a diffusion bonding member having high mechanical properties.

As used here, the term “grain boundary migration” refers to a case in which atoms migrate through a diffusion bonding member interface through thermal diffusion, and it is different in meaning from the conventionally used grain boundary migration. As used herein, the term “grain boundary migration region” means a region where grain boundary migration occurs across the diffusion bonding member interface and no planar grain boundary is observed.

In one example, the alloy for diffusion bonding according to the present invention may satisfy Relationship Formula 1 below.

$${C}_{m}^{( s )} \neq {C}_{m}^{( O )} \qquad [ Relationship Formula 1 ]$$

In Relationship Formula 1 above, Cₘ^{(s)} means the chemical composition of constituent elements on the surface of the alloy for diffusion bonding, and Cₘ^{(O)} means the chemical composition of constituent elements in the matrix of the alloy for diffusion bonding.

The fact that the alloy for diffusion bonding according to the present invention satisfies Relationship Formula 1 above may mean that the chemical composition of the constituent elements on the surface of the alloy for diffusion bonding is different from the chemical composition of the constituent elements in the alloy matrix for diffusion bonding. The different chemical compositions of the constituent elements may mean that the constituent elements are different, the content ratios of the constituent elements are different, or the average chemical compositions may be different.

The method for preparing an alloy for diffusion bonding according to the present invention may include (a) a coating step of forming an alloy precursor layer including nickel (Ni) on the surface of a base material.

The method of forming an alloy precursor layer including nickel (Ni) on the surface of a base material in the coating step (a) is not particularly limited. For example, the alloy precursor layer may be formed by physical vapor deposition, chemical vapor deposition, pack cementation, electro-plating or electroless plating, but the present invention is not limited thereto.

The type of constituent elements of the alloy precursor layer including nickel (Ni) that is formed in step (a) is not particularly limited, and it may be composed of a single metal, a binary alloy and a multi-component alloy. The alloy precursor layer may include, for example, nickel (Ni), and may additionally be composed of, for example, Al, Ag, Au, Co, Cu, Ni or Ti-based alloy, but the present invention is not limited thereto. In addition, the alloy precursor layer may include boron, silicon or phosphorus, which is an element that causes melting point depression, as a constituent element.

In one example, the upper limit of the thickness of the alloy precursor layer is not particularly limited, but may be, for example, 10 mm or less, 8 mm or less, 6 mm or less, 4 mm or less, 2 mm or less, or 1 mm or less. If the thickness of the alloy precursor layer is too thin, it may not be possible to sufficiently provide an element which promotes grain boundary migration on the surface of the alloy for diffusion bonding. Moreover, the constituent elements forming a secondary phase at the diffusion bonding member interface may not be sufficiently reduced. On the other hand, when the thickness of the alloy precursor layer is excessively thick, the polishing or post-heat treatment process may be excessively required. The lower limit of the thickness of the alloy precursor layer is not particularly limited, but may be, for example, 1 μm or more, 2 μm or more or 3 μm or more.

The method for preparing an alloy for diffusion bonding according to the present invention may include (b) a surface alloying step of forming an alloying region by mixing the base material and constituent elements of the alloy precursor layer. In step (b), the method is not particularly limited as long as the base material and the constituent elements of the alloy precursor layer can be mixed. For example, the mixing may be performed through ion implantation, surface treatment by using a laser, surface modification by using an electron beam, heat treatment, thermo-mechanical treatment and the like, but the present invention is not limited thereto.

Conditions such as temperature, pressure, time and the degree of vacuum of the surface alloying step are not particularly limited as long as the base material and the constituent elements of the alloy precursor layer can be mixed. For example, surface alloying may be performed by applying a pressure of 0 MPa or more or exceeding 0 MPa at a temperature above room temperature. In this case, the surface alloying time may be performed for 1 minute to 100 hours, and may be performed at a degree of vacuum below atmospheric pressure, but the present invention is not limited thereto.

The diffusion bonding method of an alloy according to the present invention may include (c) a polishing step of preparing the surface of an alloy for diffusion bonding by removing at least a portion of the alloying region.

The polishing step (c) may be a step of removing at least a portion of an alloying region including impurities and/or a secondary phase after the surface alloying step. In the above-described surface alloying step, impurities and/or secondary phases may be formed on and near the surface of the alloy, and such impurities and/or secondary phases may cause deterioration of physical properties of the alloy. The surface polishing may be performed such that a portion of the alloying region remains. Through this, it is possible to suppress the formation of a secondary phase at the interface of alloys for diffusion bonding and promote grain boundary migration during diffusion bonding.

The polishing thickness is not particularly limited as long as it can sufficiently remove impurities and/or secondary phases on and near the surface after the surface alloying step. For example, the polishing thickness may be 10 mm or less, 8 mm or less, 6 mm or less, 4 mm or less, 2 mm or less, or 1 mm or less. In addition, the lower limit of the polishing thickness is not particularly limited, but may be, for example, 1 μm or more, 2 μm or more or 3 μm or more. The polishing method of the polishing step is not particularly limited as long as a portion of the alloying region can be removed, and various known methods such as mechanical polishing or electrolytic polishing may be used.

In one example, the thickness of the alloying region of the alloy for diffusion bonding according to the present invention is not particularly limited as long as it does not impair the effect of suppressing the formation of a secondary phase described below, but may be, for example, 10 mm or less, 8 mm or less, 6 mm or less, 4 mm or less, 2 mm or less, or 1 mm or less. When the thickness of the alloying region is excessively thick, process costs for homogenizing the chemical composition at or near the interface of the diffusion bonding agent may be excessively increased. The lower limit of the thickness of the alloying region is not particularly limited, but may be, for example, 1 μm or more, 2 μm or more or 3 μm or more.

The present invention also relates to a diffusion bonding method. The diffusion bonding method according to the present invention may include a diffusion bonding step of diffusion bonding an alloy prepared through the above-described method for preparing an alloy for diffusion bonding.

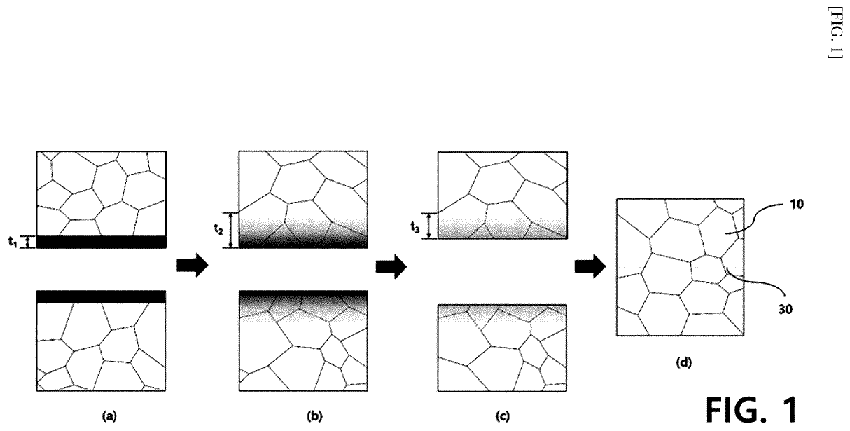

FIG. 1 mimetically shows a method for preparing an alloy for diffusion bonding and a diffusion bonding method according to the present invention. Referring to FIG. 1, the diffusion bonding method according to the present invention may prepare an alloy by the method for preparing an alloy for diffusion bonding, including (a) a coating step of forming an alloy precursor layer including nickel (Ni) on the surface of a base material; (b) a surface alloying step of forming an alloying region by mixing the base material and constituent elements of the alloy precursor layer; and (c) a polishing step of preparing an alloy surface for diffusion bonding by removing at least a portion of the alloying region, and it may include (d) a diffusion bonding step of diffusion bonding the alloy for diffusion bonding.

In this case, the diffusion bonding step may be a step of diffusion bonding alloying regions of a plurality of alloys for diffusion bonding to each other. The alloy for diffusion bonding may include an alloying region exposed to the surface, and diffusion bonding may be performed in the alloying region exposed to the surface. For example, after preparing a plurality of alloys for diffusion bonding, diffusion bonding may be performed after arranging the alloying regions of the alloys to be in contact with each other.

Diffusion bonding conditions in the diffusion bonding step are not particularly limited as long as the alloy for diffusion bonding can be diffusion-bonded. For example, it may be performed for 5 minutes to 20 hours under the conditions of room temperature or higher and pressure exceeding 0 MPa. In this case, the degree of vacuum in the diffusion bonding equipment may be 10-3 Torr or less. However, diffusion bonding conditions are not limited to the bonding temperature, bonding pressure, bonding time and the degree of vacuum.

In addition, the diffusion bonding method of an alloy according to the present invention may include post-heat treatment for 1 hour to 100 hours at a temperature range of room temperature or higher after the diffusion bonding, as necessary. In addition, after the post-heat treatment, it may be cooled to 10° C. to 30° C. through furnace cooling, air cooling or quenching.

The present invention also relates to a diffusion bonding member. The diffusion bonding member according to the present invention may be formed by diffusion bonding of a diffusion bonding member in which a plurality of alloys for diffusion bonding that are prepared by the above-described method for preparing an alloy for diffusion bonding are diffusion-bonded to each other.

In this case, the diffusion bonding member may include a diffusion bonding member interface in which the plurality of alloys for diffusion bonding are diffusion-bonded to each other, and a grain boundary migration region which is disposed on the interface.

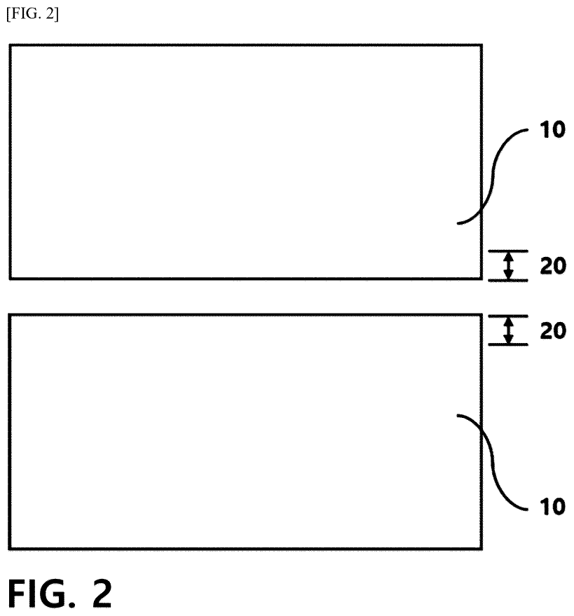

FIG. 2 mimetically shows the cross sections of a plurality of alloys 10 for diffusion bonding. An alloying region 20 is locally formed on and near the surface of the alloy 10 for diffusion bonding. The chemical composition of the constituent elements in the matrix under the alloying region 20 is the same as that of the matrix constituent elements.

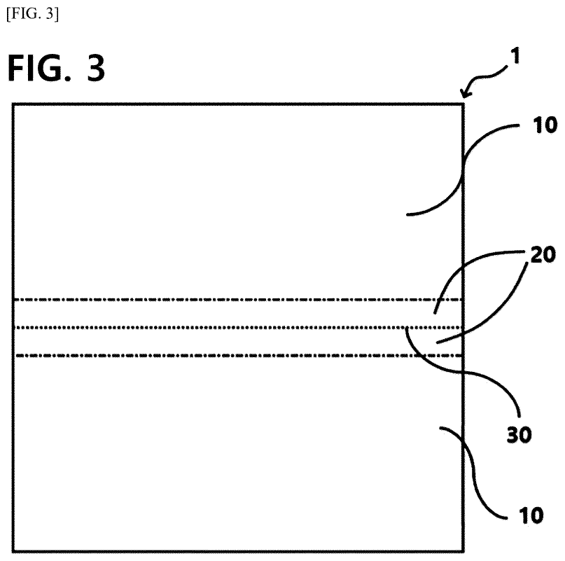

FIG. 3 is a mimetic diagram of the cross section of a diffusion bonding member according to the present invention. The diffusion bonding member of the present invention includes a plurality of alloys 10 for diffusion bonding and a diffusion bonding member interface 30 which is disposed between the plurality of alloys 10 for diffusion bonding. Atoms mutually diffuse through diffusion bonding and post-heat treatment such that the chemical composition of constituent elements at and near the diffusion bonding member interface 30 becomes homogeneous. In particular, the chemical composition of the constituent elements in the alloying region 20 is at the level of the base material alloy, and satisfies the material specification (e.g., ASTM B409) standards of the base material alloy.

In an exemplary embodiment of the present invention, the diffusion bonding member according to the present invention may satisfy Relationship Formula 2 below.

$${L}_{2} / {L}_{1} \geq 0.20 \qquad [ Relationship Formula 2 ]$$

In Relationship Formula 2 above, L₁ is the total length of the diffusion bonding member interface 30, and L₂ is the length of the grain boundary migration region.

The ratio (L₁/L₂) means the ratio of the lengths of the region where grain boundary migration occurs across the diffusion bonding member interface. The upper limit of the ratio is not particularly limited, but may be, for example, 1.0 or less.

The ratio may mean a ratio of the lengths of the region where grain boundary migration occurs across the diffusion bonding member interface, and the upper limit is not particularly limited, but may be, for example, 1.0 or less. When the diffusion bonding member according to the present invention satisfies Relationship Formula 2 above, the formation of planar crystal grain boundaries may be suppressed and the mechanical properties of the diffusion bonding member may be improved.

In one example, the diffusion bonding member according to the present invention may satisfy Relationship Formula 3 below.

$$T {S}_{D} / T {S}_{B} \geq 0.80 \qquad [ Relationship Formula 3 ]$$

In Relationship Formula 3 above, TS_{D} is the tensile strength of the diffusion bonding member at room temperature and high temperature, and TSB is the tensile strength of the base material at room temperature and high temperature. In the present specification, the base material refers to an alloy base material that has not undergone a preparation step for manufacturing an alloy for diffusion bonding. Relationship Formula 3 above means that the tensile strength of the diffusion bonding member at room temperature and high temperature is 80% or more of the tensile strength of the alloy base material at room temperature and high temperature. The improvement of mechanical properties according to the present invention is achieved because the formation of the secondary phase at the diffusion bonding member interface is suppressed.

The diffusion bonding member according to the present invention may satisfy Relationship Formula 4 below.

$$E {L}_{D} / E {L}_{B} \geq 0.60 \qquad [ Relationship Formula 4 ]$$

In Relationship Formula 4 above, EL_{D} is the elongation rate of the diffusion bonding member at room temperature and high temperature, and EL_{B} is the elongation rate of the base material at room temperature and high temperature. Relationship Formula 4 above means that the elongation rate of the diffusion bonding member at room temperature and high temperature according to the present invention is 60% or more compared to the base material. As described above, the improvement of mechanical properties according to the present invention is achieved because the formation of the secondary phase at the diffusion bonding member interface is suppressed.

In the present specification, room temperature may mean about 25° C., and high temperature may mean about 600° C. For example, when the diffusion bonding member according to the present invention satisfies Relationship Formula 3 above, it may mean that the tensile strength of the diffusion bonding member at room temperature is 80% or more of the tensile strength of the alloy base material at room temperature, and at the same time, it may mean that the tensile strength of the diffusion bonding member at high temperature is 80% or more of the tensile strength of the alloy base material at high temperature.

In addition, when the diffusion bonding member according to the present invention satisfies Relationship Formula 4 above, it may mean that the elongation rate of the diffusion bonding member at room temperature is 60% or more compared to the base material, and at the same time, it may mean that the elongation rate of the diffusion bonding member at high temperature is 60% or more compared to the base material.

In addition, the present invention may provide a plate heat exchanger which is manufactured by using the diffusion bonding method of an alloy.

Recently, the growth trend of the market for introducing renewable energy and stable power generation system is steadily increasing. The growth projections for the North American and European heat exchanger markets (2020-2025) are $4.7 billion (3.4% CAGR) and $5.02 billion (3.2% CAGR), respectively. Considering the market trend toward energy efficiency improvement, the growth of the plate heat exchanger market is also expected to be positive. The present invention has been devised in accordance with the trend of the times and is expected to have a high industrial ripple effect in relation to the manufacturing technology of small reactor steam generators and the manufacturing technology of heat exchangers for hydrogen stations. In addition, it is expected to contribute to product/technology exports by revitalizing the stagnant domestic manufacturing sector and strengthening external competitiveness.

Hereinafter, preferred examples are presented to aid understanding of the present invention. However, the following examples are provided to more easily understand the present invention, and the content of the present invention is not limited by the following examples.

### EXAMPLE

### Preparation of Alloy for Diffusion Bonding

Two plate-shaped alloys (Alloy 800H) were prepared for the fabrication of alloys for diffusion bonding. The chemical composition of the alloys used in the examples is shown in Table 1 below.

TABLE 1

| | Ni | Cr | Al | Ti | C | Si | Mn | S | P | Fe |
|---|---|---|---|---|---|---|---|---|---|---|
| Composition | 31.52 | 19.71 | 0.52 | 0.58 | 0.08 | 0.32 | 0.73 | 0.001 | 0.017 | 45.6 |
| (wt. %) | | | | | | | | | | |

Examples of the base material alloy in the present invention may include Alloy 800H (UNS N08810), but the present invention is not limited thereto. The base material alloy may include 30.0 to 35.0 wt. % of nickel (Ni); 19.0 to 23.0 wt. % of chromium (Cr); 0.15 to 0.60 wt. % of aluminum (Al); 0.15 to 0.60 wt. % of titanium (Ti); 0.05 to 0.10 wt. % of carbon (C); and the remainder of iron (Fe).

In addition, the base material alloy may further include 0.75 wt. % or less of copper (Cu), 1.0 wt. % or less of silicon (Si), 1.5 wt. % or less of manganese (Mn) and 0.015 wt. % or less of sulfur(S), as necessary, but the present invention is not limited thereto.

Hereinafter, the role and effect of each element will be explained:

### (1) Iron (Fe)

The iron is an element serving as a base metal. The iron content in the alloy includes at least 39.5 wt. % or more. In nickel-based heat-resistant alloys, iron is used to replace expensive elements such as nickel or cobalt. When iron is added to the nickel-based heat-resistant alloy, workability of the material may be facilitated.

### (2) Nickel (Ni)

The nickel is an element added to stabilize the austenite structure, and the nickel content in the alloy may be 30.0 to 35.0 wt. %. In this case, when the nickel content is less than 30.0 wt. %, stability, corrosion resistance and strength of the structure at high temperatures may be deteriorated.

### (3) Chromium (Cr)

The chromium is an element for increasing high-temperature oxidation resistance, and the chromium content in the alloy may be 19.0 to 23.0 wt. %. In this case, when the chromium content is less than 19.0 wt. %, an oxide film may not be stably formed at high temperature, and when the chromium content is more than 23.0 wt. %, a secondary phase may be formed due to thermal aging.

### (4) Aluminum (Al)

The aluminum is an element that increases high-temperature corrosion resistance and increases the strength of the material at high temperatures according to the precipitate strengthening effect. The aluminum content in the alloy may be 0.15 to 0.60 wt. %. In this case, when the aluminum content is less than 0.15 wt. %, high-temperature corrosion resistance and precipitate strengthening effect may not be obtained, and when the aluminum content is more than 0.60 wt. %, a secondary phase may be formed due to thermal aging.

### (5) Titanium (Ti)

The titanium is an element for the precipitate strengthening effect, and the titanium content in the alloy may be 0.15 to 0.60 wt. %. When the titanium content is less than 0.15 wt. %, creep strength and oxidation resistance may be reduced, and if it is more than 0.60 wt. %, a secondary phase may be formed due to thermal aging.

Meanwhile, the alloy for diffusion bonding according to the present invention may further include 0.75 wt. % or less of copper (Cu), 1.0 wt. % or less of silicon (Si), 1.5 wt. % or less of manganese (Mn) and 0.015 wt. % or less of sulfur(S), as necessary, but the present invention is not limited thereto. The elements may be a type of impurity that is inevitably included in the manufacture of a material, but when the content range is satisfied, physical properties such as high-temperature strength may be improved.

### (a) Coating Step

An alloy precursor layer including nickel (Ni) was applied to the surfaces of the two base material alloys. The upper limit of the thickness of the alloy precursor layer is not particularly limited, but may be, for example, 10 mm or less, 8 mm or less, 6 mm or less, 4 mm or less, 2 mm or less, or 1 mm or less. In addition, the lower limit of the thickness of the alloy precursor layer is not particularly limited, but may be, for example, 1 μm or more, 2 μm or more or 3 μm or more.

### (b) Surface Alloying Step

The alloy to which an alloy precursor layer including nickel was applied was heat-treated to perform surface alloying. The heat treatment was performed at a temperature near (±150° C.) the solution heat treatment temperature (at least 1,149° C.), and the heat treatment was terminated after the alloying had progressed sufficiently. The heat treatment time is not particularly limited as long as the surface alloying can progress sufficiently, but may be performed for, for example, 1 minute to 100 hours. After the heat treatment, the alloyed base material was cooled under conditions in which surface oxidation did not occur.

### (c) Polishing Step

The surface of the alloy base material in which the surface was alloyed was mechanically polished in the depth direction to remove the surface. The mechanical polishing may be performed within the thickness range of the alloy precursor layer formed in the above-described coating step. The thickness of the surface removed through the mechanical polishing may be, for example, 10 mm or less, 8 mm or less, 6 mm or less, 4 mm or less, 2 mm or less or 1 mm or less, and the lower limit of the thickness may be 1 μm or more, 2 μm or more or 3 μm or more, but is not limited thereto.

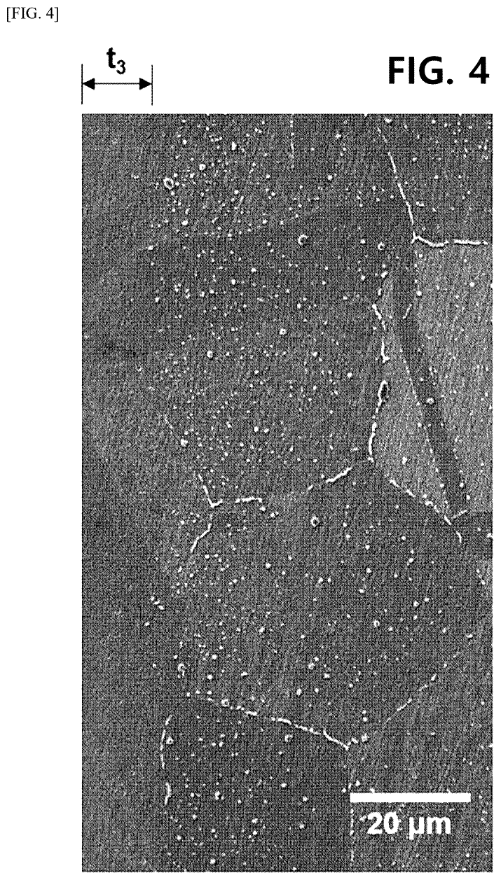

FIG. 4 is a SEM image of a cross-section of an alloy for diffusion bonding. Referring to FIG. 4, Cr-rich carbides are not observed in the region of t₃ after polishing the surface. This is because Cr-rich carbides in the t3 region were dissolved into the matrix. In contrast, as shown in FIG. 4, precipitates that did not dissolve into the matrix are observed in a region deeper than t3.

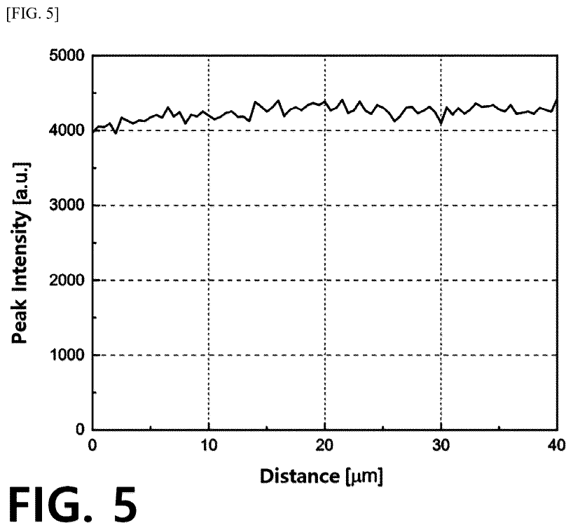

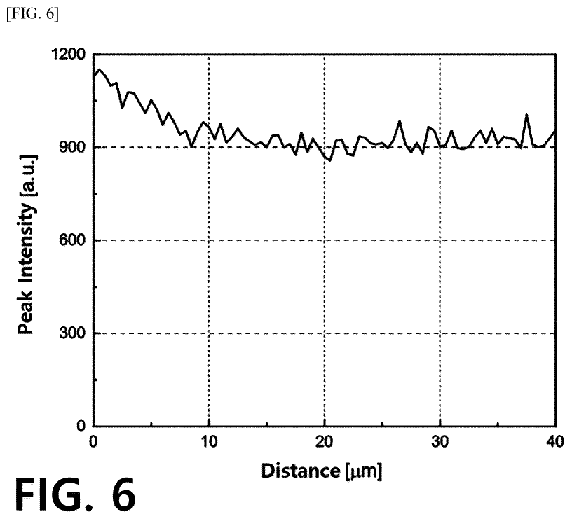

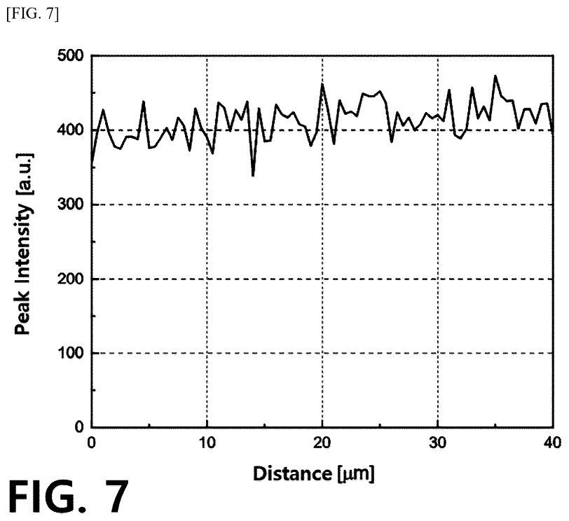

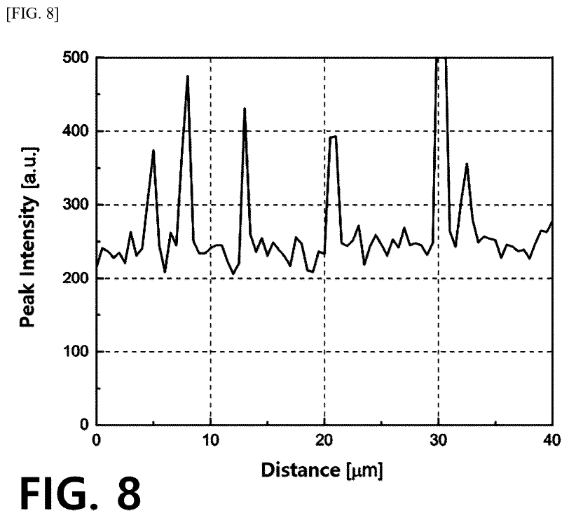

FIGS. 5 to 8 are the results of analyzing the cross section of the alloy for diffusion bonding by using the EPMA method. FIG. 5 shows the content of iron (Fe), FIG. 6 shows the content of nickel (Ni), FIG. 7 shows the content of chromium (Cr), and FIG. 8 shows the content of titanium (Ti), respectively. Referring to FIG. 5 and FIG. 7, it can be confirmed that the contents of iron and chromium of the alloy for diffusion bonding according to the present invention do not show a large deviation from the surface to the depth direction. In addition, referring to FIG. 8, it can be confirmed that in the case of titanium, there is a region where the peak intensity is measured to be large, but the content does not tend to increase or decrease uniformly according to the depth.

In contrast, referring to FIG. 6, nickel has a gradient in a known direction from the surface of the alloy for diffusion bonding according to the present invention to a predetermined depth. Specifically, the nickel content decreases from the surface to reach the base material level at a given depth. The chemical composition of the other constituent elements of the alloy other than nickel on and near the surface of the alloy for diffusion bonding according to the present embodiment was slightly reduced compared to the chemical composition of the constituent elements in the matrix.

### Diffusion Bonding of Alloy for Diffusion Bonding

The surface of the alloy for diffusion bonding was washed with ethanol, and diffusion bonding was performed after arranging two sheets of the alloy for diffusion bonding to face each other. Diffusion bonding was performed for 1 hour at a bonding temperature of 1,150° C., a bonding pressure of 10 MPa and a vacuum degree of 10⁻⁵ Torr.

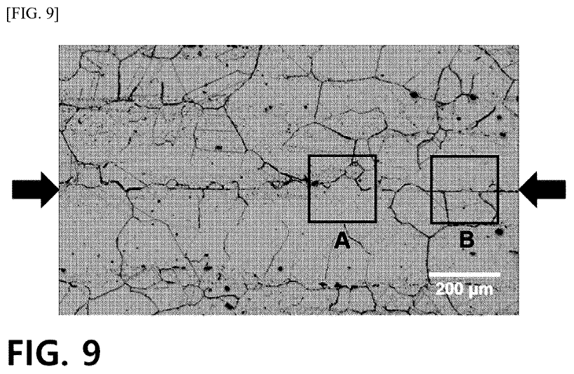

FIG. 9 is an image of a cross section of the diffusion bonding member according to the present exemplary embodiment taken with an optical microscope (OM). In FIG. 9, arrows indicate diffusion bonding member interfaces. Region A in FIG. 9 means a grain boundary migration region. Referring to region A of FIG. 9, it can be confirmed that grain boundary migration has occurred across the diffusion bonding member interface. On the other hand, it can be confirmed that the grain boundary migration across the diffusion bonding member interface does not occur in region B.

### COMPARATIVE EXAMPLE

60 alloys (Alloy 800H) were diffusion-bonded under conditions similar to those of the example (1,150° C./10 MPa/1 hour) without performing steps (a) to (c) above.

### Test Example

A tensile test was performed on the diffusion bonding members manufactured in the example and comparative example. Specifically, tensile test specimens were taken from the diffusion bonding members manufactured in the example and comparative example, and a tensile test was performed according to ASTM E8/E8M at room temperature (25° C.) and 600° C.

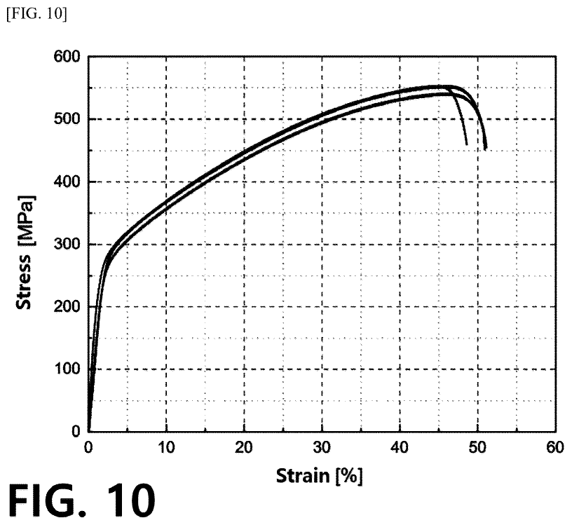

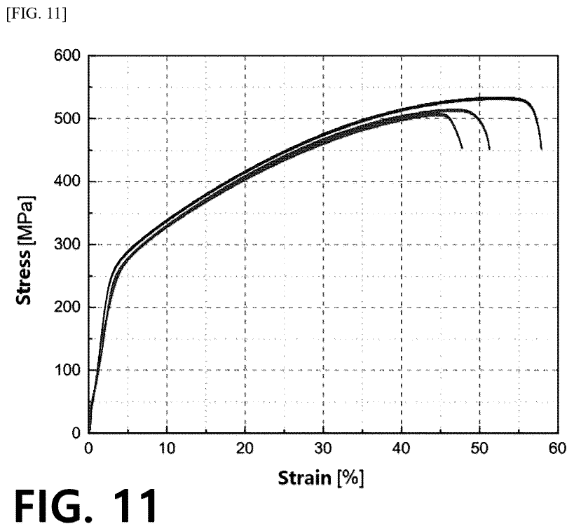

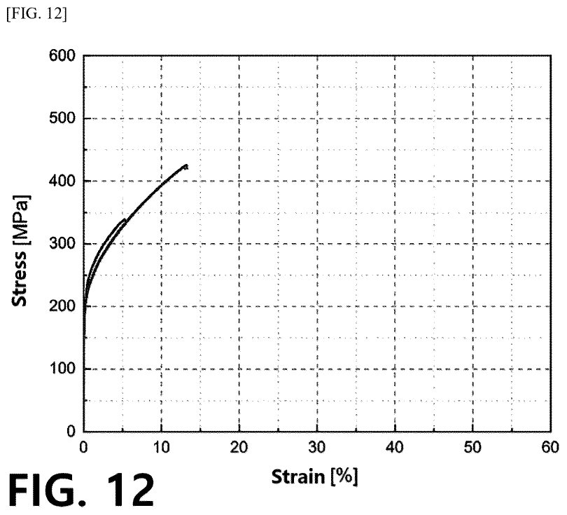

FIGS. 10 to 12 are stress-strain curves at room temperature of the base material, the example and comparative example, respectively.

The tensile strength of the base material at room temperature is 547±6 MPa, and the elongation rate is 50.2±1.3%. The diffusion bonding member according to the embodiment has a tensile strength of 518±13 MPa at room temperature and an elongation rate of 52.2±5.1%. Meanwhile, the tensile strength of the comparative example at room temperature is 395±49 MPa, and the elongation rate is 10.5±4.4%.

Through the above results, it can be confirmed that the diffusion bonding member of the example has a tensile strength of 95% compared to the base material at room temperature, but has a tensile strength of 72% compared to the base material in the case of the comparative example. In addition, it can be confirmed that the elongation rate of the diffusion bonding member of the example and the diffusion bonding member of the comparative example at room temperature is 103% and 21%, respectively, compared to the base material.

Through the tensile test results, it can be confirmed that the mechanical properties at room temperature of the diffusion bonding member manufactured by using the present invention are improved compared to the diffusion bonding member manufactured according to the related art. In addition, it was confirmed that the mechanical properties at room temperature of the diffusion bonding member manufactured by using the present invention reached the mechanical properties of the base material at room temperature.

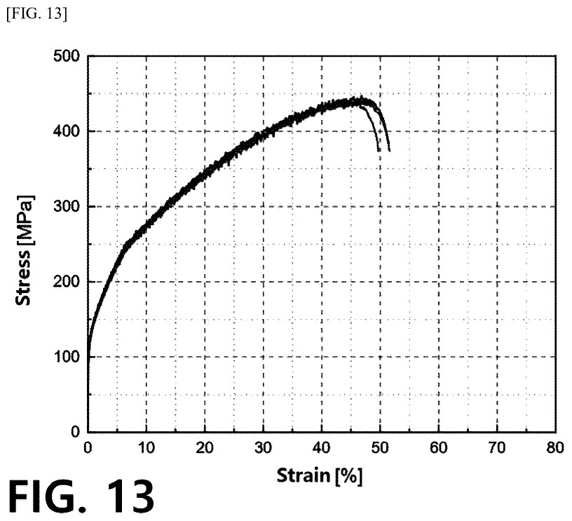

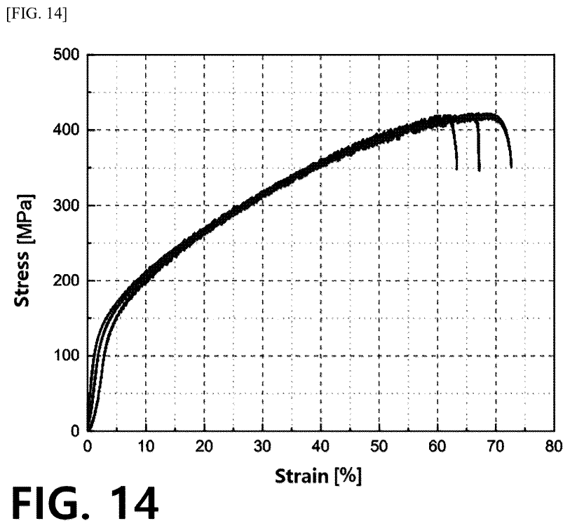

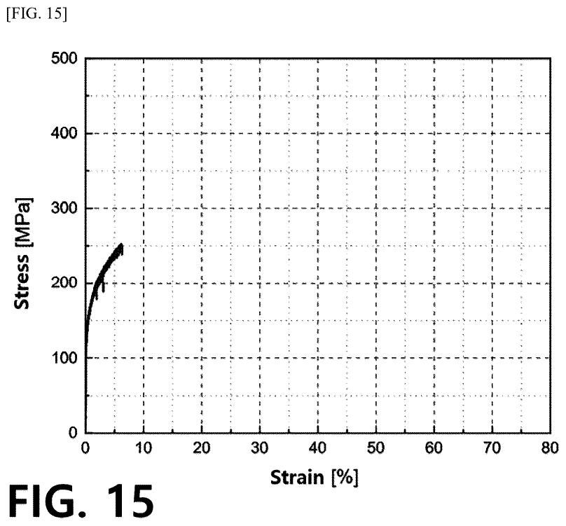

FIGS. 13 to 15 are stress-strain curves at 600° C. of the base material, the example and comparative example, respectively.

The tensile strength of the base material at 600° C. is 441±4 MPa, and the elongation rate is 50.8±1.0%. The tensile strength at 600° C. of the diffusion bonding member according to the example of the present invention is 421±1 MPa, and the elongation rate is 67.8±3.6%. Meanwhile, the diffusion bonding member of the comparative example has a tensile strength of 220±23 MPa at 600° C. and an elongation rate of 3.7±1.8%.

Through the above results, it can be confirmed that the tensile strength of the diffusion bonding member of the example at 600° C. is 95% compared to the base material, but the tensile strength of the comparative example is only 49% compared to the base material. Meanwhile, it can be confirmed that the elongation rates of the diffusion bonding member of the example and the diffusion bonding member of the comparative example at 600° C. are 133% and 7%, respectively, compared to the base material.

Through the above results, it can be confirmed that the mechanical properties of the diffusion bonding member of the present invention at 600° C. as well as room temperature correspond to the mechanical properties of the base material at 600° C. In addition, it can be confirmed that the mechanical properties at high temperatures of the diffusion bonding member manufactured by using the present invention are improved compared to the related art.

The above description of the present invention is for illustrative purposes, and those skilled in the art will understand that it can be easily modified into other specific forms without changing the technical spirit or essential features of the present invention. Therefore, the exemplary embodiments described above should be understood as illustrative in all respects and not restrictive.

### INDUSTRIAL APPLICABILITY

One of the various effects of the present invention is to minimize the formation of a secondary phase at or near the diffusion bonding member interface.

One of the various effects of the present invention is that it is possible to form a grain boundary migration region across the diffusion bonding member interface.

One of the various effects of the present invention is to provide a diffusion bonding member and a diffusion bonding method of an alloy having mechanical properties comparable to those of a base material at room temperature and high temperature.

1. A method for preparing an alloy for diffusion bonding comprising a matrix and an alloying region having a different chemical composition from the matrix, the method comprising:
(a) a coating step of forming an alloy precursor layer comprising nickel (Ni) on the surface of a base material;
(b) a surface alloying step of forming an alloying region by mixing the base material and constituent elements of the alloy precursor layer; and
(c) a polishing step of preparing an alloy surface for diffusion bonding by removing at least a portion of the alloying region.

2. The method of claim 1, wherein at least a portion of the alloying region is exposed to the surface of the alloy for diffusion bonding.

3. The method of claim 1, wherein the method satisfies Relationship Formula 1 below:
$${C}_{m}^{( s )} \neq {C}_{m}^{( O )} \qquad [ Relationship Formula 1 ]$$
wherein in Relationship Formula 1 above, Cₘ^{(s)} means the chemical composition of constituent elements on the surface of the alloy for diffusion bonding, and Cₘ^{(O)} means the chemical composition of constituent elements in the matrix of the alloy for diffusion bonding.

4. The method of claim 1, wherein the coating thickness of the alloy precursor layer is 10 mm or less.

5. The method of claim 1, wherein the polishing step removes a portion of the alloying region including impurities and/or secondary phases.

6. The method of claim 1, further comprising:
a diffusion bonding step of diffusion bonding the alloy for diffusion bonding.

7. The method of claim 6, wherein the diffusion bonding step is a step of diffusion bonding of alloying regions of a plurality of diffusion bonding alloys to each other.

8. A diffusion bonding member in which a plurality of alloys for diffusion bonding prepared by the method for preparing an alloy for diffusion bonding according to claim 6 are diffusion-bonded, the diffusion bonding member comprising:
a diffusion bonding member interface in which the plurality of alloys for diffusion bonding are diffusion-bonded to each other; and
a grain boundary migration region which is disposed on the interface.

9. The diffusion bonding member of claim 8, wherein the diffusion bonding member satisfies Relationship Formula 2 below:
$${L}_{2} / {L}_{1} \geq 0.20 \qquad [ Relationship Formula 2 ]$$
wherein in Relationship Formula 2 above, L₁ is the total length of the diffusion bonding member interface, and L₂ is the length of the grain boundary migration region located on the diffusion bonding member interface.

10. The diffusion bonding member of claim 8, wherein the diffusion bonding member satisfies Relationship Formula 3 below:
$$T {S}_{D} / T {S}_{B} \geq 0.80 \qquad [ Relationship Formula 3 ]$$
wherein in Relationship Formula 3 above, TS_{D} is the tensile strength of the diffusion bonding member at room temperature and high temperature, and TSB is the tensile strength of the base material at room temperature and high temperature.

11. The diffusion bonding member of claim 8, wherein the diffusion bonding member satisfies Relationship Formula 4 below:
$$E {L}_{D} / E {L}_{B} \geq 0.60 \qquad [ Relationship Formula 4 ]$$
wherein in Relationship Formula 4 above, EL_{D} is the elongation rate of the diffusion bonding member at room temperature and high temperature, and EL_{B} is the elongation rate of the base material at room temperature and high temperature.
